(19) United States
(12) Patent Application Publication
(10) Pub. No.: US 2025/0103029 A1
(43) Pub. Date: Mar. 27, 2025

(54) CONTROL CIRCUIT AND DISTRIBUTED CONTROL SYSTEM

(71) Applicant: ABB SCHWEIZ AG, Baden (CH)

(72) Inventors: Wenying Liu, Hangzhou, Zhejiang (CN); Huan Shi, Hangzhou, Zhejiang (CN); Wei Liu, Hangzhou, Zhejiang (CN)

(21) Appl. No.: 18/291,418

(22) PCT Filed: Aug. 20, 2021
(86) PCT No.: PCT/CN2021/113821

§ 371 Date: Jan. 23, 2024

(51) Int. Cl. G05B 19/418

(52) U.S. Cl. CPC G05B 19/4185; G05B 2219/31124; G05B 2219/31234

(57) ABSTRACT

A control circuit for use with a network and a distributed control system. The control circuit incudes a switch module, a communication interface module coupled to the switch module and configured to convert data sampled from industrial field into a format suitable for being transmitted to the switch module via the network, and a controller module coupled to the switch module and configured to receive the converted data from the switch module and process the converted data. The switch module is configured to enable a communication between the communication interface module and external devices outside the control circuit and a communication between the controller module and the external devices.

### FIELD

Embodiments of the present disclosure generally relate to the field of distributed control system (DCS), and more particularly, to a control circuit for use with an Ethernet and a distributed control system comprising the control circuit.

### BACKGROUND

With the trend of integration of IT and OT networks, traditional DCS systems adopting controller centric topologies are difficult to meet the requirements of the upcoming Industry 4.0. The traditional DCS systems typically utilize different kinds of communication interface (CI) cards to handle various field bus protocols. One problem of the traditional DCS systems is that the CI cards handling different kinds of field bus protocols cannot communicate with each other. Another problem of the traditional DCS systems is that, because the CI cards are only connected to the local controllers and not connected to other devices, once the controllers are broken down, data from the industrial field provided by the CI cards cannot be processed, and the operating condition of the industrial field cannot be monitored by an upper layer.

### SUMMARY

In view of the foregoing problems, various example embodiments of the present disclosure provide a control circuit and a distributed control system to enable the communication between the CI cards and the devices on the Ethernet.

In a first aspect of the present disclosure, example embodiments of the present disclosure provide a control circuit for use with an Ethernet. The control circuit comprises a switch module; a communication interface module coupled to the switch module and configured to convert data sampled from industrial field into a format suitable for being transmitted to the switch module via the Ethernet; and a controller module coupled to the switch module and configured to receive the converted data from the switch module and process the converted data, wherein the switch module is further configured to enable a communication between the communication interface module and external devices outside the control circuit and a communication between the controller module and the external devices. With these embodiments, the communication interface module can communicate with the external devices even if the controller module is broken down.

In some embodiments, the control circuit further comprises a backplane supporting the communication interface module, the controller module and the switch module, and configured to provide an Ethernet connection among the communication interface module, the controller module and the switch module. With these embodiments, the connection topology of the control circuit can be easily implemented in the backplane.

In some embodiments, the backplane comprises a plurality of slots in which the communication interface module, the controller module and the switch module are mounted. With these embodiments, the communication interface module, the controller module and the switch module can be easily expanded via the slots.

In some embodiments, the communication interface module comprises a processor configured to process the data sampled from the industrial field. With these embodiments, the data from the industrial field can be processed even if the controller module is broken down.

In some embodiments, the communication interface module comprises communication ports configured to communicate with the external devices directly. With these embodiments, the communication interface module can communicate with the external devices even if the switch module is broken down.

In some embodiments, the control circuit further comprises one or more redundancy communication interface modules coupled to the switch module, and configured to provide one or more redundancy communication paths between the communication interface module and the controller module. With these embodiments, the safety of the data on the communication interface module will be enhanced.

In some embodiments, the communication interface module is coupled to the one or more redundancy communication interface modules through the Ethernet directly to exchange the converted data. With these embodiments, the communication interface module can communicate with the redundancy communication interface modules directly without occupying the bandwidth of the communication path between the communication interface module and the controller module.

In some embodiments, the control circuit further comprises one or more redundancy controller modules coupled to the switch module, and configured to provide one or more redundancy communication paths between the communication interface module and the controller module. With these embodiments, the safety of the data on the controller module will be enhanced.

In some embodiments, the controller module is coupled to the one or more redundancy controller modules through the Ethernet directly. With these embodiments, the controller module can communicate with the redundancy controller modules directly without occupying the bandwidth of the communication path between the controller module and the communication interface module or the external devices.

In some embodiments, the control circuit further comprises one or more redundancy switch modules coupled to the communication interface module and the controller module, and configured to provide one or more redundancy communication paths between the communication interface module and the controller module, between the communication interface module and the external devices, and/or between the controller module and the external devices. With these embodiments, the reliability of the communication among the communication interface module, the controller module and the external devices will be enhanced.

In a second aspect of the present disclosure, example embodiments of the present disclosure provide a distributed control system. The distributed control system comprises a plurality of control circuits according to the first aspect, wherein the switch modules of the plurality of control circuits are coupled to each other.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in examples and in a non-limiting manner, wherein:

FIG. 1 is a schematic block diagram of a control circuit in accordance with an embodiment of the present disclosure;

FIG. 2 is a schematic block diagram of a control circuit in accordance with another embodiment of the present disclosure; and

FIG. 3 is a schematic block diagram of a distributed control system in accordance with an embodiment of the present disclosure.

Throughout the drawings, the same or similar reference symbols are used to indicate the same or similar elements.

### DETAILED DESCRIPTION OF EMBODIMETNS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

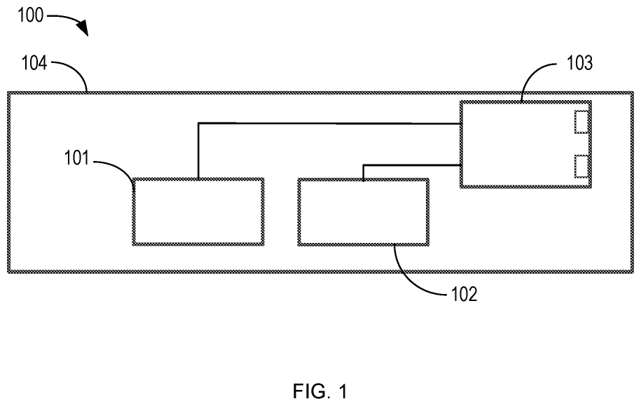

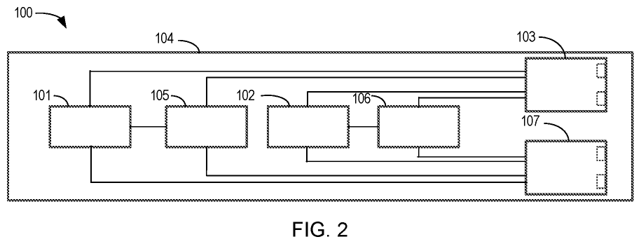

Hereinafter, the structure and operation principles of the control circuit in accordance with embodiments of the present disclosure will be described in detail with reference to FIGS. 1-2. Referring to FIG. 1 first. FIG. 1 is a schematic block diagram of a control circuit in accordance with an embodiment of the present disclosure.

As shown in FIG. 1, the control circuit 100 comprises a communication interface module 101, a controller module 102, and a switch module 103. The communication interface module 101 is coupled to the switch module 103 and is configured to convert data sampled from industrial field into a format suitable for being transmitted to the switch module 103 via the Ethernet. The controller module 102 is coupled to the switch module 103 and is configured to receive the converted data from the switch module 103 and process the converted data. The switch module 103 is configured to enable a communication between the communication interface module 101 and external devices outside the control circuit 100 and a communication between the controller module 102 and the external devices.

In a normal operation state of the control circuit 100, the communication interface module 101 samples data from sensors in the industrial field, and provide the data to the controller module 102 via the switch module 103. After the data is processed by the controller module 102, the processed data is sent back to the industrial field through the switch module 103 and the communication interface module 101 to control the devices at the industrial field. In some scenarios, the controller module 102 may send the processed data to external devices in an upper layer, for example, HMI server or engineering server, through the switch module 103, to monitor the operation condition of the devices at the industrial field.

If the controller module 102 is broken down, the communication interface module 101 will send the data sampled from sensors to the external devices through the switch module 103. Therefore, even if the local controller is broken down, the controlling of the devices at the industrial field and the monitoring of the devices at the industrial field may be maintained.

In some embodiments, the communication interface module 101 adopts OPC UA protocol. With these embodiments, the data converted by the communication interface module 101 will has a unified format that can be transmitted on the Ethernet. In other embodiments, the communication interface module 101 can adopt other protocols that are suitable for being transmitted on the Ethernet. The scope of the present disclosure is not intended to be limited in this respect.

In some embodiments, the communication interface module 101 comprises a processor configured to process the data sampled from the industrial field. With such an arrangement, the simple processing of the data can be performed in the processor, while the complicated processing of the data can be performed in the controller module 102. Accordingly, the processing efficiency of the control circuit can be improved.

In some embodiments, the communication interface module 101 comprises communication ports configured to communicate with the external devices directly, rather than through the switch module 103. With such an arrangement, the communication interface module 101 can communicate with the external devices even if the switch module 103 is broken down.

In some embodiments, the switch module 103 comprises a Time-Sensitive Network (TSN) switch. TSN is a set of standards (IEEE 802.1Q) formulated by the Time-Sensitive Network Task Group of the IEEE802.1 working group. TSN is mainly used to transmit time-sensitive real-time data on the Ethernet network. It will be one of the main network technologies in the future Industry 4.0. Combined with the OPC UA protocol, it becomes the network foundation of industrial control. With such an arrangement, real-time and non-real-time data can be transmitted simultaneously in the same Ethernet link. In other embodiments, the switch module 103 can be of other types. The scope of the present disclosure is not intended to be limited in this respect.

In some embodiments, as shown in FIG. 1, the control circuit 100 further comprises a backplane 104. The backplane 104 is used to support the communication interface module 101, the controller module 102 and the switch module 103, and is configured to provide an Ethernet connection among the communication interface module 101, the controller module 102 and the switch module 103. With such an arrangement, the connection topology of the control circuit 100 can be easily implemented in the backplane 104.

In some embodiments, the backplane 104 comprises a plurality of slots in which the communication interface module 101, the controller module 102 and the switch module 103 are mounted. With such an arrangement, the expandability of the control circuit 100 can be improved by adding or deleting the slots on the backplane 104. Moreover, by setting slots that are suitable for mounting existing CI cards, the control circuit 100 in present application can be compatible with the existing CI cards. In other embodiments, the communication interface module 101, the controller module 102 and the switch module 103 can be mounted on the backplane 104 via other connecting structures. The scope of the present disclosure is not intended to be limited in this respect.

Now referring to FIG. 2. FIG. 2 is a schematic block diagram of a control circuit in accordance with another embodiment of the present disclosure. As shown in FIG. 2, a redundancy communication interface module 105, a redundancy controller module 106, and a redundancy switch module 107 are provided in the control circuit 100.

As shown in FIG. 2, the redundancy communication interface module 105 is coupled to the switch module 103, and is configured to provide a redundancy communication path between the communication interface module 101 and the controller module 102. The data in the communication interface module 101 may be backed up in the redundancy communication interface module 105. If the communication interface module 101 is broken down, the data backed up in the redundancy communication interface module 105 will be sent to the controller module 102 or the external devices. With such an arrangement, the safety of the data on the communication interface module 101 will be enhanced.

In some embodiments, a plurality of redundancy communication interface modules 105 may be provided in the control circuit 100 to provide more than one redundancy communication paths between the communication interface module 101 and the controller module 102. The scope of the present disclosure is not intended to be limited in this respect.

In some embodiments, the communication interface module 101 is coupled to the redundancy communication interface modules 105 through the Ethernet directly to exchange the converted data. With such an arrangement, the communication between the communication interface module 101 and the redundancy communication interface modules 105 will not occupy the bandwidth of the communication path between the communication interface module 101 and the controller module 102.

As shown in FIG. 2, the redundancy controller module 106 is coupled to the switch module 103, and is configured to provide a redundancy communication path between the communication interface module 101 and the controller module 102. The data in the controller module 102 may be backed up in the redundancy controller module 106. If the controller module 102 is broken down, the data backed up in the redundancy controller module 106 will be sent to the communication interface module 101 or the external devices. With such an arrangement, the safety of the data on the controller module 102 will be enhanced.

In some embodiments, a plurality of redundancy controller modules 106 may be provided in the control circuit 100 to provide more than one redundancy communication paths between the communication interface module 101 and the controller module 102. The scope of the present disclosure is not intended to be limited in this respect.

In some embodiments, the controller module 102 is coupled to the redundancy controller modules 106 through the Ethernet directly. With such an arrangement, the communication between the controller module 102 and the redundancy controller modules 106 will not occupy the bandwidth of the communication path between the controller module 102 and the communication interface module 101 or the external devices.

As shown in FIG. 2, the redundancy switch module 107 is coupled to the communication interface module 101 and the controller module 102, and is configured to provide redundancy communication paths between the communication interface module 101 and the controller module 102, between the communication interface module 101 and the external devices, and between the controller module 102 and the external devices. If the switch module 103 is broken down, the redundancy switch module 107 can be used to provide redundancy communication paths. With such an arrangement, the reliability of the communication among the communication interface module 101, the controller module 102 and the external devices will be enhanced.

In some embodiments, a plurality of redundancy switch modules 107 may be provided in the control circuit 100 to provide more than one redundancy communication paths. The scope of the present disclosure is not intended to be limited in this respect.

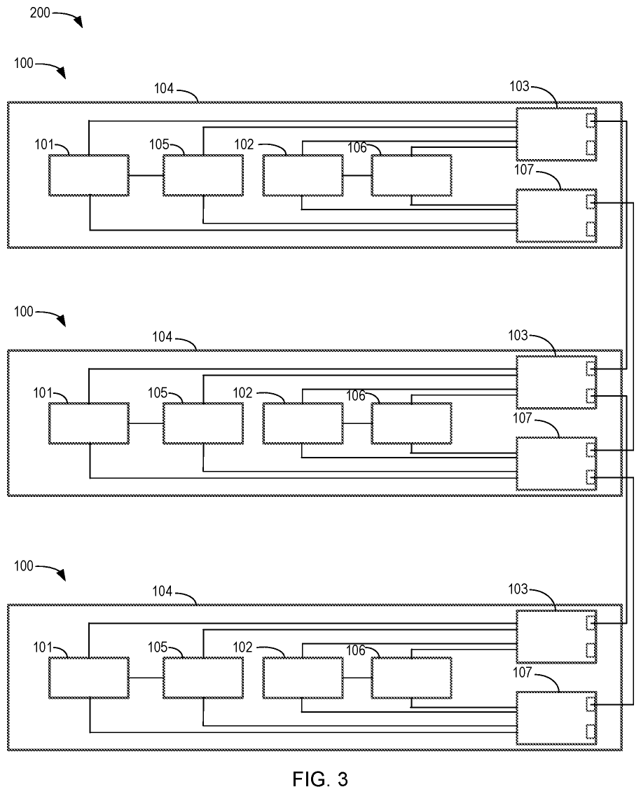

FIG. 3 is a schematic block diagram of a distributed control system in accordance with an embodiment of the present disclosure. Hereinafter, principles of the distributed control system in accordance with embodiments of the present disclosure will be described in detail with reference to FIG. 3.

As shown in FIG. 3, the distributed control system 200 comprises a plurality of control circuits 100 described above with reference to FIG. 2. In some embodiments, the switch modules 103 of the plurality of control circuits 100 are coupled to each other. In other embodiments, the switch modules 103 of the plurality of control circuits 100 are coupled to an external switch module to provide communication paths with another DCS. It is to be understood that, in other embodiments, the distributed control system 200 may comprise a plurality of control circuits 100 of other structures. The scope of the present disclosure is not intended to be limited in this respect.

Since all the data transmitted on the Ethernet has a unified format, the data on the communication interface module 101 can be backed up on any communication interface module on the Ethernet, the data on the controller module 102 can be backed up on any controller module on the Ethernet. With such an arrangement, the robustness of the distributed control system can be improved.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A control circuit for use with an Ethernet network, comprising:
a switch module;
a communication interface module coupled to the switch module and configured to convert data sampled from industrial field into a format suitable for being transmitted to the switch module via the Ethernet network; and
a controller module coupled to the switch module and configured to receive the converted data from the switch module and process the converted data,
wherein the switch module is further configured to enable a communication between the communication interface module and external devices outside the control circuit and a communication between the controller module and the external devices.

2. The control circuit according to claim 1, further comprising:
a backplane supporting the communication interface module, the controller module and the switch module, and configured to provide an Ethernet connection among the communication interface module, the controller module and the switch module.

3. The control circuit according to claim 2, wherein the backplane comprises a plurality of slots in which the communication interface module, the controller module and the switch module are mounted.

4. The control circuit according to claim 1, wherein the communication interface module comprises a processor configured to process the data sampled from the industrial field.

5. The control circuit according to claim 1, wherein the communication interface module comprises communication ports configured to communicate with the external devices directly.

6. The control circuit according to claim 1, further comprising:
one or more redundancy communication interface modules coupled to the switch module, and configured to provide one or more redundancy communication paths between the communication interface module and the controller module.

7. The control circuit according to claim 6, wherein the communication interface module is coupled to the one or more redundancy communication interface modules through the Ethernet network directly to exchange the converted data.

8. The control circuit according to claim 1, further comprising:
one or more redundancy controller modules coupled to the switch module, and configured to provide one or more redundancy communication paths between the communication interface module and the controller module.

9. The control circuit according to claim 8, wherein the controller module is coupled to the one or more redundancy controller modules through the Ethernet network directly.

10. The control circuit according to claim 1, further comprising:
one or more redundancy switch modules coupled to the communication interface module and the controller module, and configured to provide one or more redundancy communication paths between the communication interface module and the controller module, between the communication interface module and the external devices, and/or between the controller module and the external devices.

11. A distributed control system, comprising:
a plurality of control circuits according to claim 1, wherein the switch modules of the plurality of control circuits are coupled to each other.

12. The distributed control system of claim 11, wherein each of the plurality of control circuits comprises:
a backplane supporting the communication interface module, the controller module and the switch module, and configured to provide an Ethernet connection among the communication interface module, the controller module and the switch module.

13. The distributed control system of claim 12, wherein the backplane of the each of the plurality of control circuits comprises a plurality of slots in which the communication interface module, the controller module and the switch module are mounted.

14. The distributed control system of claim 11, wherein the communication interface module of the each of the plurality of control circuits comprises a processor configured to process the data sampled from the industrial field.

15. The distributed control system of claim 11, wherein the communication interface module of the each of the plurality of control circuits comprises communication ports configured to communicate with the external devices directly.

16. The distributed control system of claim 11, wherein each of the plurality of control circuits comprises:
one or more redundancy communication interface modules coupled to the switch module, and configured to provide one or more redundancy communication paths between the communication interface module and the controller module.

17. The distributed control system of claim 16, wherein the communication interface module of the each of the plurality of control circuits is coupled to the one or more redundancy communication interface modules through the Ethernet network directly to exchange the converted data.

18. The distributed control system of claim 11, wherein each of the plurality of control circuits comprises:
one or more redundancy controller modules coupled to the switch module, and configured to provide one or more redundancy communication paths between the communication interface module and the controller module.

19. The distributed control system of claim 18, wherein the controller module of the each of the plurality of control circuits is coupled to the one or more redundancy controller modules through the Ethernet network directly.

20. The distributed control system of claim 11, wherein each of the plurality of control circuits comprises:
one or more redundancy switch modules coupled to the communication interface module and the controller module, and configured to provide one or more redundancy communication paths between the communication interface module and the controller module, between the communication interface module and the external devices, and/or between the controller module and the external devices.
